(19) United States
(12) Patent Application Publication
(10) Pub. No.: US 2011/0203051 A1
(43) Pub. Date: Aug. 25, 2011

(54) Support devices

(76) Inventor: Thomas Bartlett Snell, Sherborne (GB)

(21) Appl. No.: 12/932,502

(22) Filed: Feb. 25, 2011

(30) Foreign Application Priority Data
Feb. 25, 2010 (GB) 1003218.3

(51) Int. Cl. A61G 13/00; B60B 33/00; B60B 33/02

(52) U.S. Cl. 5/601; 5/600

(57) ABSTRACT

A support device for use in supporting an animal during the carrying out of a magnetic resonance imaging (MRI) scan includes a main bed (A) on which the body of an animal can be supported and an auxiliary unit (J), which is movable relative to the main bed (A) and on which structures are provided for supporting a limb of the animal on the main bed (A) while an MRI scan is carried out on the limb.

### CROSS REFERENCE TO RELATED APPLICATION

This application claims priority under 35 USC §119(e) to United Kingdom Patent Application No. 1003218.3 filed on Feb. 25, 2010.

### TECHNICAL FIELD

This invention relates to support devices, particularly support devices for use by veterinary surgeons.

### BACKGROUND OF THE INVENTION

Veterinary surgeons scan animals internally by various methods, including magnetic resonance image scanning, otherwise known as MRI scanning, using X-rays and ultrasound. This imagery is used to assist diagnosis for subsequent surgery, physical and medical treatments, and physiotherapy and exercise programmes.

Horses, in particular, frequently suffer from lameness and other limb disorders and injuries and the advent of MRI scanning has frequently enabled veterinary surgeons to pinpoint the problems more rapidly than other methods. At times it is the only scanning method that will provide the necessary information.

A horse's limbs may, in some cases, be scanned by MRI with the horse standing on all four legs and under sedation. It is, however, absolutely essential that the horse stands virtually motionless for some time to achieve satisfactory results but some horses are unable to stand sufficiently still, even under heavy sedation.

In a standing situation, the part of a limb nearest the hoof is normally the least subject to movement due to its close proximity to the stationary hoof on the ground. The stifle (knee) of a horse is further from the ground and movement here is more of a problem. Thus there are frequently situations where it is not satisfactory to carry out an MRI scan with the horse standing. This is usually due to the horse's inability to stand still and there are some spirited horses that cannot be calmed at all.

### OBJECTS OF THE INVENTION

It is accordingly an object of the present invention to provide a support device that can be used for supporting and positioning an animal's limbs while the animal is under general anaesthesia, particularly while carrying out an MRI scanning procedure.

More specifically, it is an object of the present invention to eliminate the problems that have been caused by movement of an animal's limbs and to provide means for adjustment of the position of a limb (that may be locked or unlocked as required) relative to the scanning device and the patient's abdomen.

### SUMMARY OF THE INVENTION

According to a first aspect of the present invention there is provided a support device which includes a main bed on which the body of an animal can be supported and an auxiliary unit, which is movable relative to the main bed and on which means are provided for supporting a limb of the animal on the main bed.

According to a second aspect of the present invention there is provided the combination of an MRI scanner and a support device which includes a main bed on which the body of an animal can be supported and an auxiliary unit, which is movable relative to the main bed and on which means are provided for supporting a limb of the animal on the main bed while an MRI scan is carried out on the limb.

The animal will typically be a horse which, under general anaesthesia, may be laid on its side in lateral recumbency with the abdomen and head of the animal on the main bed.

To position the horse, it will first be induced in a veterinary padded room and lifted by travelling hoist by its limbs and rolled flat onto a wheeled bed. The horse will then be wheeled into the magnetically screened MRI scanning room near to the scanner, maintained under anaesthesia and made ready for scanning. The offending limb may be arranged to lie generally horizontally and outstretched projecting off the side of the main bed of the support device and independently by the support means on the auxiliary unit with the length of limb to be scanned (usually the lower limb or hoof area) left overhanging for entry of the limb into the jaws of the scanner's magnet. The remaining limbs may be positioned on or close to the edge of the main bed and secured in place using soft ropes as necessary.

The main bed preferably comprises a mobile platform with a flat top surface fitted with rolling means for movement over the floor in the x, y and slew planes. The rolling means are typically castor wheels that can swivel. They may be equipped with wheel brakes and swivel locks.

The main bed may be provided with a cushion, such as a fluid-filled mattress or an air cushion. It may comprise a number of stacked sections that can be fastened together and the uppermost cushion, i.e. the one in contact with the patient, may be inflated to a lower pressure than the or each lower cushion in order to conform to the animal's profile and minimise pressure-related problems, particularly with prolonged general anaesthesia. The lower cushion or cushions at higher pressure maintain stability.

The top surface of the platform on which the cushions are disposed preferably has a roughened texture to prevent the mattress from sliding. The platform may be fitted with removable handles, one at each end, that may be dropped into place or lifted out at will.

The auxiliary unit may be covered by a mattress or by a stack of mattresses, with the top of the mattress or stack of mattresses parallel to the floor. The auxiliary unit may be provided with castors and position locking means to provide freedom to position the auxiliary unit relative to the main bed.

Once a suitable layout for the limb to be scanned has been established, the auxiliary unit is preferably connected to the main bed by an arm assembly that may be adjusted and locked as required, thereby securing the position of the auxiliary unit relative to the main bed. If the bed is then moved around the floor, the auxiliary unit will then move with it, leaving the limb to be scanned in exactly the same position in relation to the abdomen of the animal. The bed and auxiliary unit can thus be moved together into the jaws of the magnet of the scanner in readiness for a scanning procedure.

For fine positioning of the limb, the locks on the auxiliary unit can be released and fine adjustment of the position of the auxiliary unit can be carried out. This is far more controllable than trying to move the whole assembly of main bed, horse and auxiliary unit. On reaching the desired final position, the locks may be secured and screw jacks engaged with the floor if ultimate stability is required.

The design of the scanner is preferably such that its position can be adjusted vertically and, to a very small extent, in other planes. When wishing to scan other sites on the same limb, repositioning of the limb can be effected by releasing the locks and moving the auxiliary unit into the required position before relocking and stabilising the auxiliary unit. At the end of the scanning session, the arm assembly may be removed and the auxiliary unit wheeled away to allow the patient to be returned to the recovery room.

The arm assembly on the auxiliary unit may include a Vernier adjustment facility in the x, y and slew planes. If the auxiliary unit does not have an adjustable arm assembly, this will limit the capabilities of the support device. Thus, in a basic form, the auxiliary unit may comprise a stack of mattresses on the floor that can be slid or carried into position as required. By lifting the patient's limb by hand and then lowering it to the new position (and repeating as necessary), the required position for the limb can be reached. This is labour-intensive but may be acceptable in some circumstances. The number of mattresses that are used can be such as to raise the patient to waist or chest height for engagement with higher scanners.

Although reference has been made above to use of the support device for a patient in a laterally recumbent position, it will be appreciated that the device can also be used in another MRI scanning configuration in which, the patient, typically a horse, can be scanned lying on its back with its offending leg held vertically by a rigid holding means.

The body of the patient is cradled by a shaped fluid-filled mattress assembly, air being preferred, resting on the platform with the remaining limbs secured or left in a closed condition. The induction of the patient is as described above for lateral recumbency, but with hoisting of the patient onto the mattress assembly on its back. This arrangement has the advantage that good access can be obtained for scanning the stifle and upper part of the limb of the horse. There is, however, a disadvantage in that the requirement for the scanner to rise to a greater height increases the cost of the scanner because of rigidity issues. In addition MRI scanners with sufficient power to scan the stifle require considerably more power, hence increased weight and additional cost. In addition image access to a hoof may be compromised as a result of the use of attachment means fastened to the lower limb or hoof.

When scanning is being carried out with the animal in dorsal recumbency, one or more substantial interfaces are used to support the upright. Only one upright will be used at a time, but alternative positions offer close access capability for any one of the four limbs. When scanning in dorsal recumbency, the auxiliary unit will not normally be used. It will be appreciated that both configurations have their advantages and disadvantages but the support device of the present invention, which is capable of use with both configurations, has its definite benefits.

All the components of the support device will normally be inert or virtually inert to high magnetic fields to ensure correct imaging functions and safety. The principal materials are typically aluminium, stainless steel and plastics materials. It will be appreciated that, although the support device of the present invention has been designed for use with an MRI scanner, it can be used for other purposes.

### BRIEF DESCRIPTION OF THE DRAWINGS

FIG. 1 is a perspective view of a mobile platform device,

FIG. 2 is a perspective view of the mobile platform device with mattresses on its upper surface and removable handles at each end,

FIG. 3 is an underneath perspective view of the mobile platform device shown in FIG. 2,

FIG. 4 is a perspective view of the support device of the present invention when carrying out an MRI scan in lateral recumbency,

FIG. 5 is a plan view of the device and scanner of FIG. 4,

FIG. 6 is a perspective view of the main body of an auxiliary unit for supporting a limb of an animal,

FIG. 7 is a perspective view of the mobile platform device of FIG. 2 and the auxiliary unit of FIG. 6 interconnected by an arm assembly,

FIG. 8 is a perspective view of the arm assembly shown in FIG. 7,

FIG. 9 is an enlarged detail view of part of the arm assembly,

FIG. 10 is an exploded perspective view of part of the arm assembly,

FIG. 11 is a perspective view of the platform of the support device of the present invention and an MRI scanner for the carrying out of a scan in dorsal recumbency,

FIG. 12 is a further perspective view of the arrangement shown in FIG. 11, and

FIG. 13 is an underneath perspective view of part of the platform device showing an interface in the platform chassis that has a hole for locating an upright member for supporting a limb of an animal in dorsal recumbency.

### DESCRIPTION OF THE PREFERRED EMBODIMENT

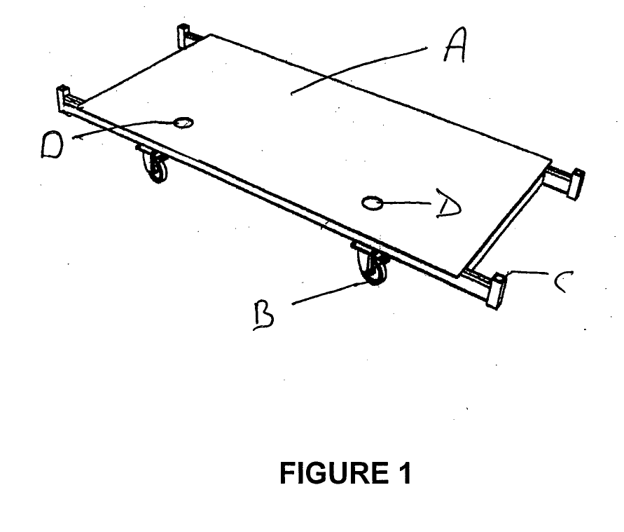

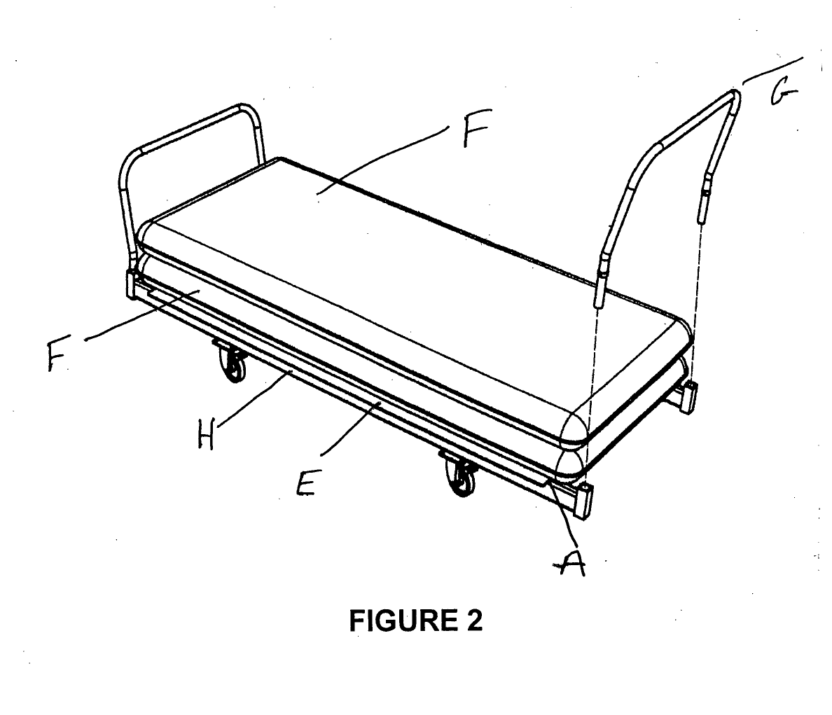

FIG. 1 shows a level platform A that has castor wheels B that can swivel and have brakes that can be operated to prevent rotation and swivelling of the wheels B. At each end of the platform A, there are vertical tubes C that support handles G (see FIG. 2). Deep vertical holes D are formed in the platform A and, as described below, either of these can be used to locate a rigid support tube used when carrying out a scanning procedure on an animal, e.g. a horse, in dorsal recumbency.

As shown in FIG. 2, the platform A, when used for carrying out a scanning procedure on an animal in lateral recumbency, has air mattresses F placed on its upper surface. A horizontally extending edge E protrudes beyond the frame H of the platform A and this edge E is used for attachment of an arm assembly, as described below, anywhere along its length on either side of the platform A.

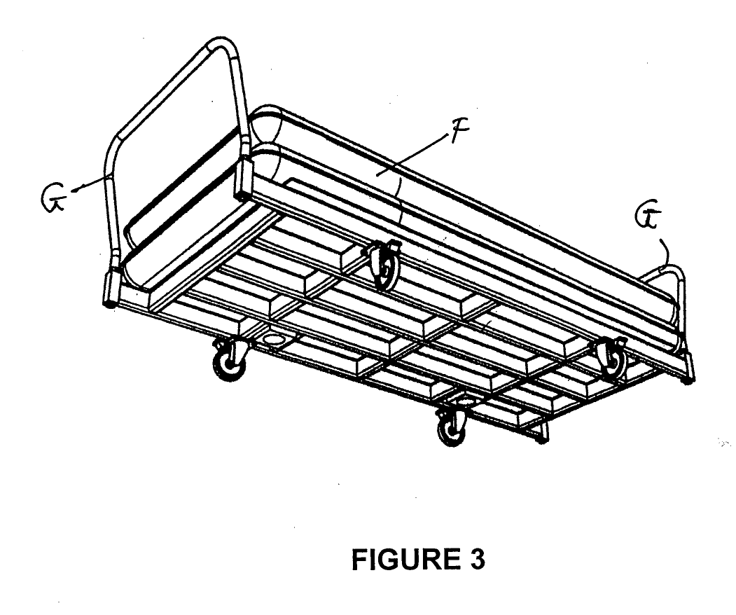

FIG. 3 is an underneath perspective view of the bed arranged for moving a horse in lateral recumbency from an induction knock-down room to the MRI scanning room.

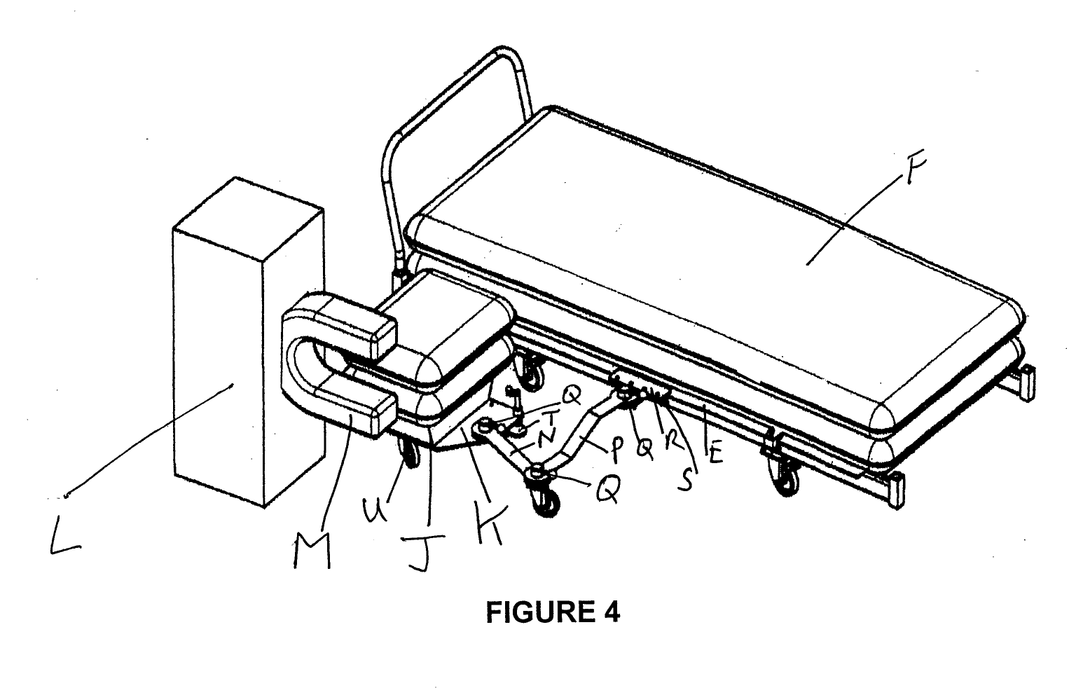

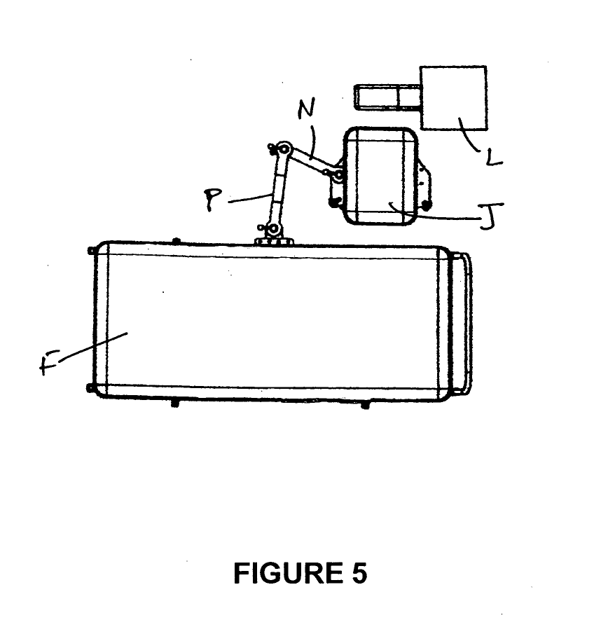

FIGS. 4 and 5 show the bed prepared for the carrying out of a scanning procedure with the horse in its lateral recumbency mode and with an auxiliary unit J for supporting the limb to be scanned. The auxiliary unit J comprises a base or platform K supported by three castors U that engage the floor. The castors U do not have brakes or swivel locks. The top of the base or platform K carries air cushions that can be attached to the base K and to each other. The uppermost cushion, i.e. the one in contact with the patient, may be inflated to a lower pressure than the or each lower cushion in order to conform to the animal's profile and to minimise pressure-related problems, particularly with prolonged general anaesthesia. The lower cushion or cushions are at a higher pressure to maintain stability.

The bed and the auxiliary unit J are linked by an arm assembly comprising two arms N and P. Arm N carries a swivelling castor acting on the floor to assist the support of the arm assembly. Half-turn locks Q are used to freeze a position setting. A clevis block R is located at the required position along the rail interface E and is slid along and locked in position, as required, by means of manually operated screws S under the block R.

The bed with the auxiliary unit J locked in position by means of the arm assembly can be moved bodily, with the horse lying on the bed on its side and with the limb to be scanned resting on the top of the air cushions of the auxiliary unit J. The scanner L is normally in a fixed position with the jaws of the magnet M of the scanner extending horizontally. The bed is moved into an approximate position and fine positioning is then effected, releasing one or more of the locks Q, as required. Once the required final position has been obtained, the chosen position is then secured by means of screw jacks T that engage with the floor.

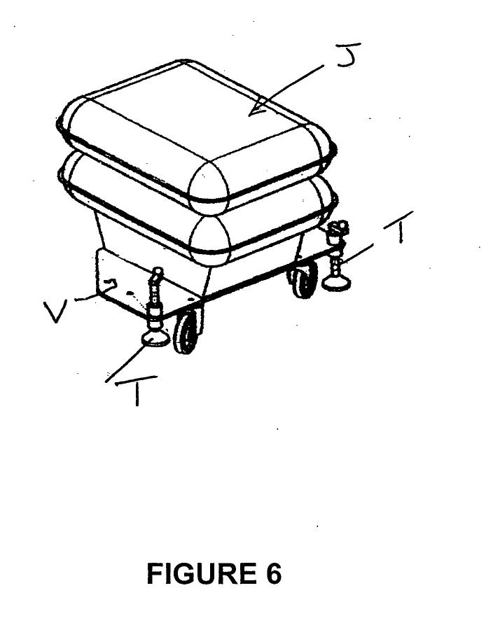

The range of movement of the auxiliary unit J is almost limitless and it may be used for fore limbs or hind limbs, left or right, on either side of the platform A. The auxiliary unit J can be swung, angled, extended as required with the arm assembly placed on either side of the auxiliary unit J. The auxiliary unit J preferably has three castors U to obtain maximum stability and the single castor U may be either at the front or back of the unit J. Two or more screw jacks T (see FIG. 6) on the auxiliary unit J are operated to ensure a high level of stability.

FIG. 6 is a view of the auxiliary unit J showing the screw jacks T and holes V in a horizontal plate forming part of the auxiliary unit. The holes V are used to receive and locate an end of the drop-in arm assembly N, P.

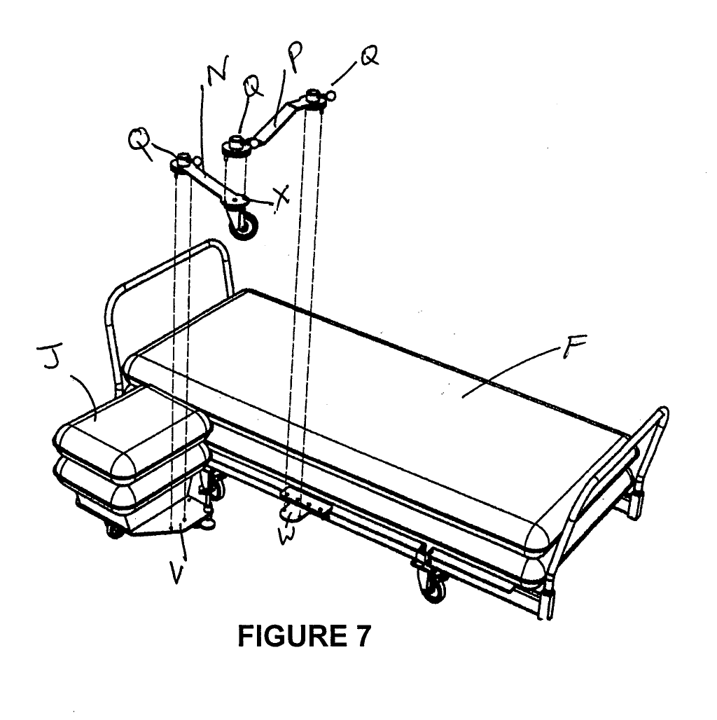

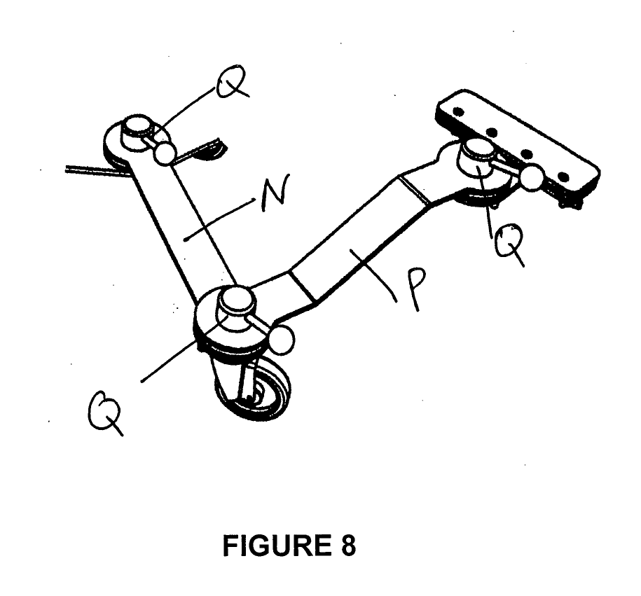

FIG. 7 shows the relative positions of the parts of the arm assembly and how it can simply be dropped into place. Arm N is placed in position, locating into holes V, followed by arm P placed on top of arm N and locating into holes X and W. If the position of the auxiliary unit J relative to the main bed needs to be changed, the locks Q will need to be slackened. FIG. 8 shows the arm assembly on its own.

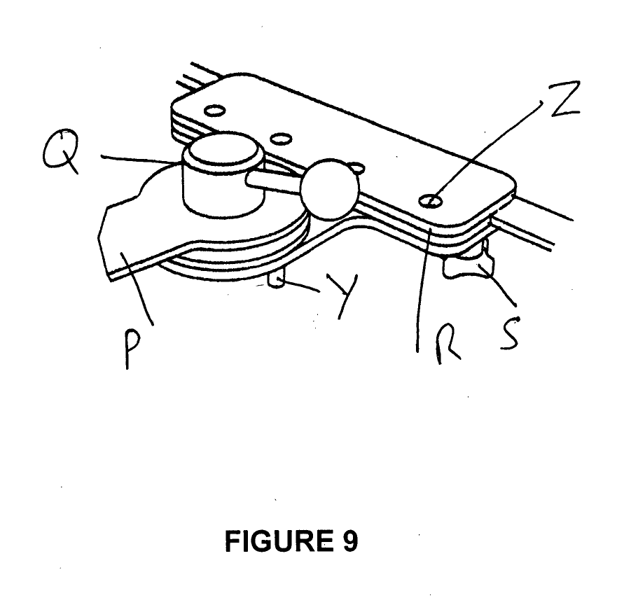

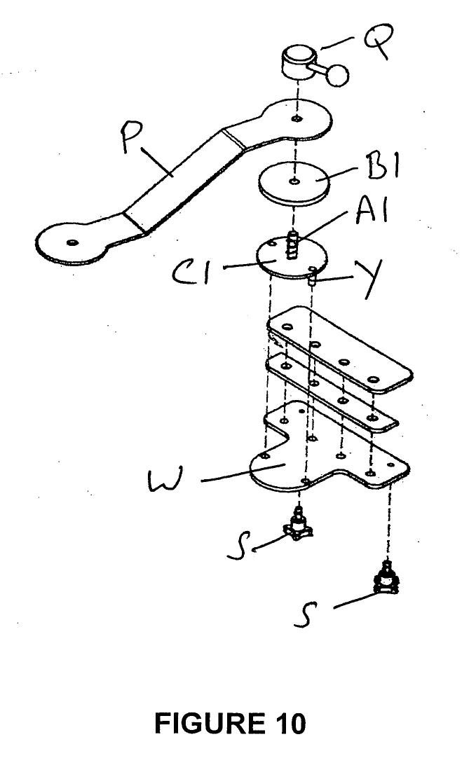

FIG. 9 shows the relationships between the arms N and P and the clevis block R, which is held together by not and bolt fasteners (not shown in FIG. 9) passing through holes Z. FIG. 10 is an exploded view and shows that plate C1 has two pins Y that project downwardly for fitment in holes W. Plate C1 has an upwardly projecting, centrally located threaded stud A1 that passes through an opening in a rigid friction disc pad B1 and then passes through a hole in arm P. A lock Q comprising a female thread, a boss and a handle is used to clamp the arm P to plate C1. Slight slackening of the lock Q allows relative movement of the various parts so that they can be set as required. The other arm connections work on the same principle.

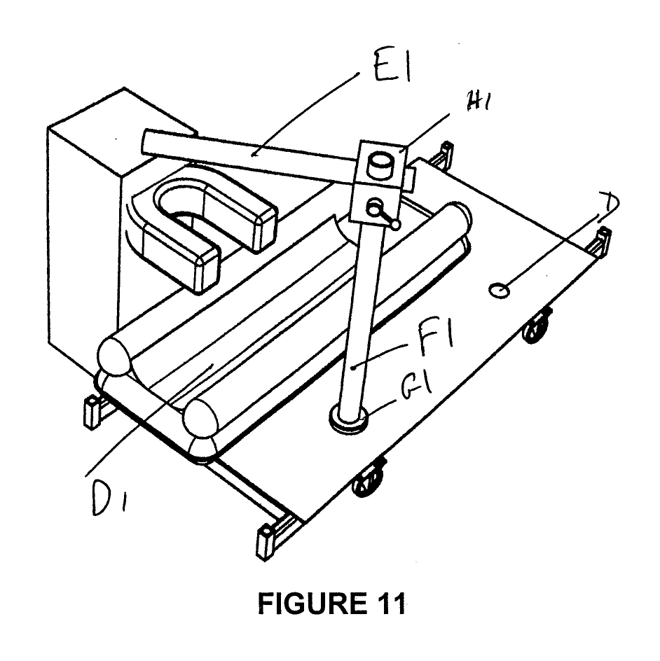

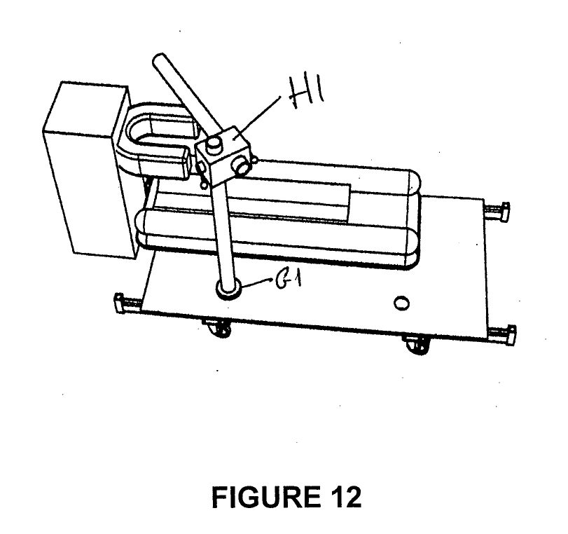

FIGS. 11 and 12 shows the apparatus prepared for the carrying out of a scanning procedure in the dorsal recumbency mode, i.e. with the horse patient laid on its back and with the limb to be scanned extending generally vertically upwards. The back of the horse is located in the cushion set D1 and the limb to be scanned is secured to a beam E1 which is adjustably clamped to an upright member F1 by means of a clamping block H1 that incorporates screw clamps that engage with the beam E1 and the upright member F1.

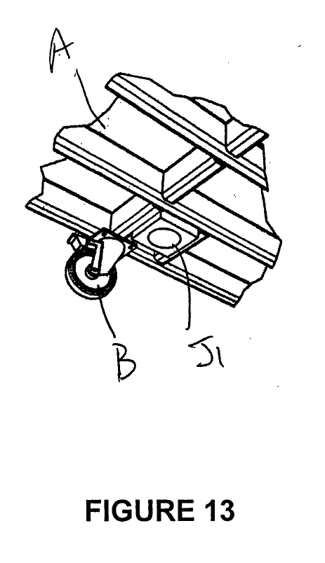

As will be appreciated from a comparison of FIGS. 11 and 12, limbs can be scanned from various positions making use of the holes D formed in the platform A to receive the upright member F1. The upright member F1 prevented from falling through the hole D by the provision of a flange G1, the flange G1 being an integral part of the upright member F1. FIG. 13 shows the underside of the chassis of the platform A and a hole block J1 that is incorporated in the chassis of the platform A and affords a hole D.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A support device which includes a main bed on which the body of an animal can be supported and an auxiliary unit, which is movable relative to the main bed and on which means are provided for supporting a limb of the animal on the main bed.

2. The combination of a magnetic resonance imaging (MRI) scanner and a support device which includes a main bed on which the body of an animal can be supported and an auxiliary unit, which is movable relative to the main bed and on which means are provided for supporting a limb of the animal on the main bed while an MRI scan is carried out on the limb.

3. A support device as claimed in claim 1, in which the main bed comprises a mobile platform with a flat top surface fitted with rolling means for movement over a floor in the x, y and slew planes.

4. A support device as claimed in claim 3, in which the rolling means are castor wheels that can swivel.

5. A support device as claimed in claim 4, in which the castor wheels are equipped with wheel brakes and swivel locks.

6. A support device as claimed in claim 1, in which the main bed is provided with a cushion that comprises a number of stacked sections that can be fastened together.

7. A support device as claimed in claim 6, in which the main bed comprises a horizontal platform and in which a top surface of the platform on which the cushion is disposed has a roughened texture to prevent the cushion from sliding.

8. A support device as claimed in claim 7, in which the platform is fitted with removable handles, one at each end.

9. A support device as claimed in claim 1, in which the auxiliary unit is covered by at least one mattress, with the top of the mattress parallel to the floor.

10. A support device as claimed in claim 1, in which the auxiliary unit is provided with castors and with position locking means to provide freedom to position the auxiliary unit relative to the main bed.

11. A support device as claimed in claim 1, which includes an adjustable arm assembly for connection of the auxiliary unit to the main bed.

12. The combination claimed in claim 2, in which the main bed comprises a mobile platform with a flat top surface fitted with rolling means for movement over the floor in the x, y and slew planes.

13. The combination claimed in claim 12, in which the rolling means are castor wheels that can swivel.

14. The combination claimed in claim 13, in which the castor wheels are equipped with wheel brakes and swivel locks.

15. The combination claimed in claim 2, in which the main bed is provided with a cushion that comprises a number of stacked sections that can be fastened together.

16. The combination claimed in claim 15, in which the main bed comprises a horizontal platform and in which the top surface of the platform on which the cushion is disposed has a roughened texture to prevent the cushion from sliding.

17. The combination claimed in claim 16, in which the platform is fitted with removable handles, one at each end.

18. The combination claimed in claim 17, in which the auxiliary unit is covered by at least one mattress, with the top of the mattress parallel to a floor on which the combination rests.

19. The combination claimed in claim 2, in which the auxiliary unit is provided with castors and with position locking means to provide freedom to position the auxiliary unit relative to the main bed.

20. The combination claimed in claim 2, which includes an adjustable arm assembly for connection of the auxiliary unit to the main bed.

21. A method of supporting a horse during the carrying out of an magnetic resonance imaging (MRI) scan which includes the use of a support device as claimed in claim 1.
